(19) United States
(12) Patent Application Publication
(10) Pub. No.: US 2002/0029177 A1
(43) Pub. Date: Mar. 7, 2002

(54) Method and system for attracting and retaining employees

(76) Inventor: Jeffery A. Smisek, Houston, TX (US)

Correspondence Address: VINSON & ELKINS, 2300 FIRST CITY TOWER, 1001 FANNIN STREET, HOUSTON, TX, 770026760

(21) Appl. No.: 09/821,678

(22) Filed: Mar. 29, 2001

Related U.S. Application Data
(60) Provisional application No. 60/193,084, filed on Mar. 30, 2000.

(51) Int. Cl. G06F 17/60

(52) U.S. Cl. 705/30

(57) ABSTRACT

A method of compensating certain employees is provided, which includes the steps of establishing a benefit plan which qualifies under federal law for certain tax benefits, including within the plan the ability to obtain the benefits of large increases in value of stocks in non-traditional businesses, making plan benefits available upon continued employment with the company, identifying the key employees to whom plan participation will be offered, and offering participation in the plan to such employees. A system of compensating identified employees is also provided via the use of a computer programmed to keep track of the employment status of participating employees, the employment time periods for which benefits are to be provided, the value of the plan investments in non-traditional business during such time, and the benefits to be provided to each participating employee.

### CROSS REFERENCE TO RELATED APPLICATIONS

This application claims priority to U.S. provisional patent application Ser. No. 60/193,084 filed Mar. 30, 2000.

### BACKGROUND OF THE INVENTION

This invention relates to methods and systems to increase a company's ability to attract and retain employees, and more particularly relates to methods and systems involving the compensation of employees in certain types of businesses.

In the last several years, the growth of the Internet has created many new opportunities and challenges for existing businesses. The valuation of the stock of such new businesses (sometimes called “dot coms”) often far exceeds the value one would expect in terms of the valuation of traditional businesses, as different rules seem to apply to such new businesses from market forces. Traditional businesses often face a number of difficulties resulting from this situation. Among other things, the valuation of stock options and the like at new businesses which are based on the Internet (i.e., non-traditional businesses) create the opportunity for employees of such new businesses to obtain substantial sums of money as part of their compensation. When a “dot com” does a successful public offering, for example, employees with stock ownership feel as if they had won a lottery due to the substantial sums sometimes paid. As a result of such opportunities, or perhaps simply because of the perceived possibility of obtaining such huge rewards in a short period of time, many people are attracted to work for these non-traditional businesses. As a result, many traditional businesses find it increasingly difficult to attract and retain highly qualified employees. This problem exists at many levels, but often involves key employees in management and other positions. In addition, businesses have seen an increasingly tight labor market, thus adding to the difficulties in attracting and retaining well-qualified employees.

Simply increasing the compensation in traditional forms of salary and stock options paid to the employee have not proven an effective means of attracting and retaining such key employees for traditional businesses. This is especially true when the non-traditional businesses offer stock options and the potentially huge jump in their stock value as a part of a compensation package.

Accordingly, it is an object of the invention to provide a method and system to allow businesses to attract and retain employees in a competitive employment environment.

It is another object of the invention to provide a method and system to compensate employees, or at least key employees, in such a way as to make it easier to attract and retain such employees.

It is still another object of the invention to provide a method and system for compensation to some or all employees in a traditional business in a way which takes into account the possibly large gains from the stock value of non-traditional, Internet-based businesses.

These objects, and others, will be apparent from the detailed description of the invention which follows.

### SUMMARY OF THE INVENTION

In accordance with the present invention, a method of compensating certain employees is provided, which includes the steps of establishing a benefit plan which qualifies under federal law for certain tax benefits, including within the plan the ability to obtain the benefits of large increases in value of stocks in non-traditional businesses, making plan benefits available upon continued employment with the company, identifying the key employees to whom plan participation will be offered, and offering participation in the plan to such employees.

In another embodiment of the invention, a system of compensating identified employees is provided via the use of a computer programmed to keep track of the employment status of participating employees, the employment time periods for which benefits are to be provided, the value of the plan investments in non-traditional business during such time, and the benefits to be provided to each participating employee.

### DETAILED DESCRIPTION OF THE INVENTION

In accordance with the present invention, a method and system for attracting and retaining employees is provided. Typically, a company will want to focus on certain employees and offer special incentives to such employees. One step of the method is identifying the employees to whom participation in a new compensation or benefit is to be offered. In the illustrative example which is provided, all officers of the rank of vice president or higher, as well as certain employees and certain officers and other employees of subsidiaries, are offered participation in the plan.

An incentive plan is created in accordance with federal and state laws regulating benefit and compensation plans, such as the federal ERISA laws. An illustrative example of such a plan and its benefits is described below. The plan is developed to include a retention award, which is a right, which vests over a period of time as established by a management committee overseeing the plan, to receive a cash payment measured by a portion of the gain and profits associated with an equity holding of the company or a subsidiary in an e-commerce or internet-based business. The committee can designate, within the applicable time period permitted by Section 162 (m) of the federal tax code, each such equity holding and establish the portion of the gain and profits in such equity holding used to measure cash payments to the holder of such retention award (e.g., such as not exceeding 3.75% for any individual holder nor 25% in the aggregate for all holders).

Following the vesting of a retention award (or at such other times and subject to such other restrictions as the applicable plan document may provide), the holder of a retention award would be entitled to receive payment of an amount, not exceeding the maximum value of the retention award, based on such holder's vested interest in such retention award and the gain and profit in the underlying equity holding, as certified by the committee as required by Section 162 (m) of the federal tax code. Payment can be made in cash and in a lump sum, except as otherwise set forth in the applicable plan document.

A retention award may terminate if the holder does not remain continuously in the employ (or in service as a director) of the company or a subsidiary at all times during the applicable vesting period, except as otherwise set forth in the applicable document.

In one example, all officers of the company at the level of Staff Vice President or more senior rank, all officers or subsidiaries of Vice President or more senior rank, and other employees of the company or a subsidiary designated by the committee are eligible to participate in the program.

The plan can be designed to retain the services of officers and other employees of the company and its subsidiaries designated by the committee by offering them the economic benefit of a portion of the gains and profits on the equity holdings of the company and its subsidiaries in e-commerce and internet-based businesses, and to incentivize those officers to grow the value of those investments. The investments, the gain and profit from which are to be used to measure payments under the program, may be selected by the committee for inclusion in the program and are expected to be principally in businesses focused on distribution and marketing channels with a lower cost to the company than traditional distribution and marketing channels. Investments can include additional equity holdings in or related to the business in which an investment is made that are acquired by the company or subsidiary based on the satisfaction of performance targets, vesting provisions, or other terms and conditions of agreements entered into by the company or a subsidiary in connection with the original investment. Of course, investments in other Internet-based businesses, not affiliated with the employer company, can also be used in accordance with the present invention.

For purposes of measurement under the program, each such investment generally can be divided into one million phantom units, and a retention award will consist of rights (“PARs”) to receive the difference, if any, between the market value of a phantom unit (generally, fair market value of an investment divided by one million) and the base value of a phantom unit (generally, for awards granted concurrently with the acquisition of the investment, the out-of-pocket cost of the investment paid to the issuer or seller thereof (but not less than $100,000) divided by one million). The fair market value of distributions received with respect to investments (including interest thereon at 7% with respect to distributions received in cash) can be included in market value. The committee can determine both market value and base value, and may (subject to certain limitations) determine that base value is greater than that described above. If the date of grant of an award is after the date of acquisition of an investment, then the base value of a phantom unit relating to that award will equal the value of such phantom unit as of such date of grant as determined by the committee in any manner that it deems appropriate. The total number of PARs that may be subject to awards granted with respect to a particular investment may not, for example, for any individual participant, exceed 3.75% of the number of phantom units into which the investment has been divided, or with respect to all participants, 25% of the number of phantom units into which the investment has been divided. Awards can vest quarterly over a four-year period, or as otherwise determined by the committee, and vesting of follow-up investments will relate back to the original investment for a participant holding an award with respect to such original investment. Of course, the given number of phantom units, as well as the applicable time periods, can be varied in accordance with the present invention.

Generally, vested awards can be redeemed at the time the company or a subsidiary disposes of an investment (including by way of distribution to stockholders), and the company can make payments of remaining unpaid amounts as related awards vest (together with interest on the unpaid amounts, such as at 7% from the date of sale or other disposition). If the investment is liquid (defined generally to mean that the company is permitted to sell all or substantially all of the investment under Rule 144 of the Securities Act, pursuant to an effective registration statement or otherwise, there is not contractual or legal prohibition on such sale, such sale will not result in short-swing profit liability to the company under Section 16(b) of the Securities Exchange Act, and there is an established trading market for the applicable securities which can be used to reasonably determine fair market value), a participant may redeem his vested awards related thereto at the end of four window periods a year, subject to, for example, a 10% of the redemption amount being forfeited to the company if the committee determines such forfeiture to be appropriate when initially making the grant of the award. At the tenth anniversary of the first date of grant of an award to any individual under the retention program related to a particular investment, the company can value such investment and all related follow-up investments and redeem all related outstanding vested awards. Before payment of any redemption amount, the committee may need to certify in writing that the related performance goal has been met (that is, that the market value of a phantom unit subject to the award exceeds the base value of the phantom unit as of the date the redemption amount is determined, and that the value of the investment to which the award related and the value of investments in different equity holdings of the same entity, together with the value of all follow-up investments with respect to such investments, exceeds the aggregate out-of-pocket cost of such investments and follow-up investments to the company and its subsidiaries paid to the issuer or seller thereof).

Awards under the retention program do not necessarily create any interest in an investment (or constitute a sale, transfer, assignment, pledge or other disposition thereof or of any interest therein), create an escrow or trust fund, create any fiduciary relationship of the company or any subsidiary or any officer, director, employee or agent thereof with respect to any investment or any participant, or restrict or affect in any way the acquisition, holding, voting, disposition or the taking of any action with respect to any investment by the company or any subsidiary.

The committee may amend or terminate the retention program at any time, provided that no amendment or termination will adversely affect the rights of holders of outstanding awards or the right to receive awards (or the base value) with respect to the follow-up investments.

The following is a draft of an Officer Retention and Incentive Award Program, which illustrates a preferred approach using the method of the present invention.

### Continental Airlines, Inc. Officer Retention and Incentive Award Program

### I. Purpose of Program

This Continental Airlines, Inc. Officer Retention and Incentive Award Program (the “Program”) has been adopted by the Human Resources Committee of the Board of Directors of Continental Airlines, Inc., a Delaware corporation (the “Company”), to implement the Retention Award provisions of the Continental Airlines, Inc. Incentive Plan 2000 (as amended from time to time, the “Incentive Plan 2000”) adopted by the Board of Directors of the Company. The Program is intended to provide a method for attracting, motivating, and retaining key employees to assist in the development and growth of the Company and its Subsidiaries. The Program and Awards hereunder shall be subject to the terms of the Incentive Plan 2000, including the limitations on the maximum amount that may be paid with respect to Awards contained therein.

### II. Definitions and Construction

2.1 Definitions.

Where the following words and phrases are used in the Program, they shall have the respective meanings set forth below, unless the context clearly indicates to the contrary:

(a) “Award” means the award of one or more PARs to a Participant under the Program in accordance with Article IV. Awards hereunder constitute Retention Awards (as such term is defined in the Incentive Plan 2000) under the Incentive Plan 2000.

(b) “Award Notice” means a written notice issued by the Company to a Participant evidencing such Participant's receipt of an Award and setting forth certain terms and conditions with respect thereto in accordance with Section 4.2.

(c) “Base Value” means, with respect to each Phantom Unit subject to an Award with a Date of Grant that is concurrent with the date of the acquisition by the Company or a Subsidiary of the Investment to which such Award relates, an amount equal to (i) the actual out-of-pocket cost of such Investment (as determined by the Committee) to the Company or a Subsidiary that is paid to the issuer or seller of such Investment (but, in no event, less than $100,000) divided by (ii) the number of Phantom Units into which such Investment is divided (with the result rounded to the nearest cent). Notwithstanding the foregoing, (i) with respect to such Awards relating to Follow-up Investments, at any time prior to a Change in Control (provided, if the Change in Control is the result of a business combination with Northwest Airlines Corporation (“Northwest”) or any Person (as defined in the Incentive Plan 2000) controlling, controlled by or under common control with Northwest, that a Change in Control shall have been deemed to occur pursuant to the first sentence of Section 5.4 hereof), and (ii) with respect to all other such Awards, the Committee may, in its sole discretion, determine at the time of the grant of any such Award that the Base Value of such a Phantom Unit shall be greater than the amount set forth in the preceding sentence, and the Committee shall make each such determination based on such factors and information as it deems relevant. If the Date of Grant of an Award is after the date of the acquisition by the Company or a Subsidiary of the Investment to which such Award relates, then the Base Value of the Phantom Unit relating to such Award shall mean the value of such Phantom Unit as of such Date of Grant as determined by the Committee in such manner as it deems appropriate, and the Committee may consider such factors and information as it deems relevant in making each such determination.

(d) “Cause” means (i) in the case of a Participant with an employment agreement with the Company or a Subsidiary, the involuntary termination of such Participant's employment by the Company (or, if applicable, a Subsidiary) under circumstances that do not require the Company (or such Subsidiary) to pay to such Participant a “Termination Payment” or “Monthly Severance Amount,” as such terms (or a comparable term) are defined in such Participant's employment agreement, and (ii) in the case of a Participant who does not have an employment agreement with the Company or a Subsidiary, the involuntary termination of such Participant's employment by the Company (or, if applicable, a Subsidiary) based upon a determination by the Committee or an authorized officer of the Company (or such Subsidiary) that such Participant has engaged in gross negligence or willful misconduct in the performance of, or such Participant has abused alcohol or drugs rendering him or her unable to perform, the material duties and services required of him or her in his or her employment.

(e) “Change in Control” shall have the same meaning as is assigned to such term under the Incentive Plan 2000, as in effect on the Effective Date.

(f) “Code” means the Internal Revenue Code of 1986, as amended.

(g) “Committee” means the individuals serving from time to time as the “Committee” under the Incentive Plan 2000.

(h) “Company” means Continental Airlines, Inc., a Delaware corporation.

(i) “Date of Grant” means the effective date of the grant of an Award to a Participant.

(j) “Disability” means, with respect to a Participant, such Participant's disability entitling him or her to benefits under the Company's group long-term disability plan; provided, however, that if such Participant is not eligible to participate in such plan, then such Participant shall be considered to have incurred a “Disability” if and when the Committee determines in its discretion that such Participant has become incapacitated for a period of at least 180 days by accident, sickness, or other circumstance which renders such Participant mentally or physically incapable of performing the material duties and services required of him or her in his or her employment on a full-time basis during such period.

(k) “Disposition” means, with respect to each Investment, a transfer, sale, exchange or other disposition of all or a portion of such Investment by the Company or a Subsidiary, as applicable, to one or more Transferees. A Disposition shall include a Stockholder Disposition. A Disposition shall not include the exercise of a convertible security (including an option or warrant), but such an exercise shall require an adjustment to related Awards pursuant to Section 4.6. The Committee may determine that a transaction involving an exchange of a security for other consideration is not a Disposition (1) to the extent such other consideration consists of securities other than cash or Publicly Traded securities that are Liquid, or (2) to the extent that such transaction is effected on a tax-free basis to the Company or the applicable Subsidiary (and, in connection with such determination, the Committee may make any appropriate adjustments to related Awards pursuant to Section 4.6). For purposes of determining Market Value under the Program, the net proceeds of a Disposition of an Investment shall be allocated to Phantom Units in accordance with the number of Phantom Units into which such Investment is divided.

(l) “Distribution” means, with respect to each Investment, a dividend or other distribution (other than a dividend or distribution that the Committee has determined should be included as a part of such Investment or with respect to which an adjustment is made to an outstanding Award pursuant to Section 4.6) received with respect to such Investment by the Company or a Subsidiary, as applicable. For purposes of determining Market Value under the Program, Distributions with respect to an Investment shall be allocated to Phantom Units in accordance with the number of Phantom Units into which such Investment is divided.

(m) “Effective Date” means Mar. 27, 2000.

(n) “Eligible Employee” means any individual who is an Officer or any other person in an employment relationship with the Company or any parent or subsidiary corporation (as defined in Section 424 of the Code).

(o) “Excess Disposition” shall have the meaning assigned to such term in Section 6.2(a).

(p) “Existing Investment” shall have the meaning set forth in Section 2.1(q) as it applies to a particular Follow-up Investment.

(q) “Follow-up Investment” means, with respect to each equity holding in an e-commerce or internet-based business that already constitutes an Investment subject to the Program (an “Existing Investment”), any other equity holding in or related to such business that is acquired by the Company or a Subsidiary based on the satisfaction of performance targets, vesting provisions, or other terms and conditions set forth in one or more agreements (as the same may be amended from time to time) to which the Company or a Subsidiary is a party, which agreement(s) were entered into in connection with (and at or around the time the Company or a Subsidiary acquired) the Existing Investment.

(r) “Incentive Plan 2000” means the Continental Airlines, Inc. Incentive Plan 2000, as amended from time to time.

(s) “Investment” means each equity holding of the Company or a Subsidiary in an e-commerce or internet-based business. Equity holdings in different but affiliated entities shall be considered separate Investments, and different equity holdings in the same entity shall be considered separate Investments. The term “Investment” shall include a Follow-up Investment, but each Follow-up Investment shall be considered a new separate Investment. Notwithstanding the foregoing, with respect to an equity holding in an e-commerce or internet-based business (other than an equity holding that constitutes a Follow-up Investment) that is acquired by the Company or a Subsidiary after the Effective Date, the Company's Chief Executive Officer shall provide prompt written notice to the Committee of the acquisition of such equity holding, and such equity holding shall be considered an Investment subject to the Program as of the date of its acquisition unless (i) the Company's Chief Executive Officer fails to provide such notice to the Committee within 60 days after the date of such acquisition or (ii) the Committee determines (in its sole discretion), within 90 days after the date of such acquisition, that such equity holding shall not be considered an Investment for purposes of the Program, and delivers written notice thereof within such 90 day period to the Secretary of the Company. If the Chief Executive Officer fails to give the notice specified in clause (i) of the foregoing sentence within the time period specified therein, the Committee may nonetheless at any time determine that an equity holding in an e-commerce or internet-based business that is acquired by the Company or a Subsidiary after the Effective Date shall be considered an Investment for purposes of the Program, provided that any Award (other than an Award with respect to a Follow-up Investment) relating thereto is made by the Committee within 90 days after such determination by the Committee. With respect to each equity holding so considered an Investment for purposes of the Program acquired by the Company or a Subsidiary after the Effective Date, the Committee shall determine, within 90 days after the date of such acquisition (or, with respect to an Award described in the immediately preceding sentence, at the time of the Award), whether a Participant will forfeit 10% of the Redemption Amount upon a redemption of the Award (or any portion thereof) relating to such Investment pursuant to Section 6.1 hereof. In connection with the adoption of the Program, the Committee shall designate which Investments acquired prior to the Effective Date by the Company or a Subsidiary shall be subject to the Program as of such date, and whether a Participant will forfeit 10% of the Redemption Amount upon a redemption of any of the Awards (or any portion thereof) relating to such Investments pursuant to Section 6.1 hereof. For purposes of Section 2.1(q) and this Section 2.1(s), an “equity holding” means any interest (including, without limitation, an option or warrant) in an entity other than an instrument that is treated as indebtedness under applicable local law and which has no substantial equity features.

(t) “Investment Period” means (i) with respect to each Investment (other than a Follow-up Investment), the 10-year period beginning on the first Date of Grant of an Award to any individual with respect to such Investment, and (ii) with respect to each Follow-up Investment, the 10-year period beginning on the first Date of Grant of an Award to any individual with respect to the original Existing Investment to which such Follow-up Investment relates.

(u) “Liquid” shall mean, with respect to each Investment, a determination by the Committee that (i) the Company or a Subsidiary, as applicable, could sell all or substantially all of such Investment under Rule 144 promulgated under the Securities Act of 1933, pursuant to an effective registration statement under the Securities Act of 1933 (or under a similar procedure under foreign law), or otherwise without material transfer restrictions being imposed on a non-affiliate Transferee as a result thereof, (ii) any such sale is not prohibited by law, regulation, court or administrative order, rule of an exchange or market, contract, or otherwise, (iii) any such sale will not result in liability of the Company or any Subsidiary under Section 16(b) of the Securities Exchange Act of 1934, as amended (either because of transactions (including Award redemptions) already effected or because of prospective transactions (including Award redemptions) determined by the Committee to be reasonably probable), and (iv) there is an established public trading market for the securities comprising such Investment which can be used to reasonably determine the Market Value of the Phantom Units relating to such Investment. An Investment shall also be considered Liquid if the Committee determines that the Company or a Subsidiary could readily acquire by conversion, exchange, exercise or otherwise one or more securities that satisfy the requirements set forth in the preceding sentence with respect to all or substantially all of such Investment, and, under such circumstances, the Committee shall make appropriate and equitable adjustments to affected PARs and Awards (including, without limitation, adjustments to the determinations of the Base Value and Market Value applicable to related Phantom Units) in connection with any redemption thereof under Article VI.

(v) “Market Value” shall mean, with respect to each Phantom Unit and as of a specified date, the Committee's determination of the value of such Phantom Unit as of such date (with the result rounded to the nearest cent). Market Value shall be determined separately with respect to Awards relating to a Phantom Unit that have different Dates of Grant. Market Value shall be determined by the Committee as follows:

(i) If a Disposition (other than a Stockholder Disposition) has occurred with respect to all or a portion of the Investment to which such Phantom Unit relates, then the Market Value of such Phantom Unit as of the date of such Disposition shall equal the sum of (A) the fair market value of the Distributions allocable to such Phantom Unit that have been received by the Company or a Subsidiary with respect to such Investment from the Date of Grant of the applicable Award to the date of such Disposition (increased, in the case of any Distribution received in cash, by 7% per annum from the date of receipt of such Distribution by the Company or a Subsidiary to the date of such Disposition) and (B) the fair market value of the net proceeds to the Company or a Subsidiary with respect to such Disposition that are allocable to such Phantom Unit. The fair market value determinations required pursuant to the preceding sentence shall be made in good faith by the Committee as of the date of such Disposition.

(ii) If a Disposition of all or a portion of the Investment to which such Phantom Unit relates has not occurred and if such Investment is Publicly Traded as of the date the Market Value of such Phantom Unit is required to be made under the Program, then the Market Value as of such date of such Phantom Unit shall equal the sum of (A) the fair market value of the Distributions allocable to such Phantom Unit that have been received by the Company or a Subsidiary with respect to such Investment from the Date of Grant of the applicable Award to the date of such valuation (increased, in the case of any Distribution received in cash, by 7% per annum from the date of receipt of such Distribution by the Company or a Subsidiary to the date of such valuation) and (B) the fair market value of such Phantom Unit based on the average of the high and low sales price of the security that constitutes the related Investment as of the date of such valuation (or the next following Trading Day on which a sale occurs if no sale occurs on such date) on the principal exchange for such Investment. The fair market value determinations required pursuant to the preceding sentence shall be made in good faith by the Committee as of the date of such valuation.

(iii) If a Stockholder Disposition of the Investment to which such Phantom Unit relates has occurred at a time when such Investment is Publicly Traded, then the Market Value of such Phantom Unit as of the date of such Stockholder Disposition shall be determined as provided in clause (ii) above (applied by substituting the date of such Stockholder Disposition for the date of such valuation referred to in clause (ii)).

(iv) If a Disposition of such Investment has not occurred and the Investment to which such Phantom Unit relates is not Publicly Traded as of the date the Market Value of such Phantom Unit is required to be made under the Program, then the Market Value shall be determined by the Committee. The Committee's determination shall be made in good faith and shall be based on a valuation opinion prepared by a Valuation Expert who shall be selected by the Committee. The Committee shall cause the opinion of the Valuation Expert (who shall determine the fair market value of the Investment to which such Phantom Unit relates) to be prepared no later than 60 days after the date as of which the Market Value is being determined. The Market Value determined by the Committee based on the opinion of the Valuation Expert shall be increased by the Committee to reflect the fair market value (determined in good faith by the Committee) of the Distributions allocable to such Phantom Unit that have been received by the Company or a Subsidiary with respect to such Investment from the Date of Grant of the applicable Award to the date of such valuation (increased, in the case of any Distribution received in cash, by 7% per annum from the date of receipt of such Distribution by the Company or a Subsidiary to the date of such valuation). All costs and expenses of the Valuation Expert shall be borne by the Company.

(w) “Measurement Date” shall have the meaning assigned to such term in Section 6.3.

(x) “Nonvested PARs” means the PARs subject to a Participant's Award that are not Vested PARs.

(y) “Officer” means any individual who is in an employment relationship with the Company or any parent or subsidiary corporation (as defined in Section 424 of the Code) and who is either (i) a Staff Vice President or more senior officer of the Company or (ii) a Vice President or more senior officer of a Subsidiary.

(z) “Officer Percentage” means, with respect to each Officer and each Date of Grant, the percentage (rounded as appropriate) obtained by dividing the “Classification Percentage” for such Officer obtained in accordance with the following schedule by the number of Officers as of such Date of Grant included among the “Classification of Officers” corresponding to such “Classification Percentage” as described in the following schedule, but in no event more than the “Maximum Percentage” corresponding to such “Classification Percentage:”

| | Classification | Maximum |
|---|---|---|
| Classification of Officers | Percentage | Percentage |
| Chief Executive Officer of the Company | 3.75% | 3.75% |
| President of the Company | 2.5% | 2.5% |
| Executive Vice Presidents of the Company | 3.75% | 1.25% |
| Senior Vice Presidents of the Company and | 7.1875% | 0.599% |
| President of Continental Express, Inc. | | |
| Participants in the Company's Executive | 2.8125% | 0.3125% |
| Bonus Program (and not included | | |
| in one of the above classifications) | | |
| Category 1 officers of the Company and | 0.5% | 0.25% |
| the Subsidiaries (and not included in | | |
| one of the above classifications) | | |
| Category 2 officers of the Company and | 3.5% | 0.2058% |
| the Subsidiaries (and not included in | | |
| one of the above classifications) | | |
| Category 3 officers of the Company and | 1.0% | 0.0625% |
| the Subsidiaries (and not included in | | |
| one of the above classifications) | | |

The Committee shall determine from time to time the Category 1, Category 2, and Category 3 officers of the Company and the Subsidiaries, which may be different for different Awards.

(aa) “PAR” means the right to receive the difference, if any between the Market Value of a Phantom Unit and the Base Value of such Phantom Unit.

(bb) “Participant” means an Eligible Employee who has received an Award under the Program pursuant to Article IV; provided, however, that at no time shall there be more than 100 Participants under the Program with outstanding Awards unless the Company has received an opinion of counsel acceptable to the Committee that additional Participants with outstanding Awards above such number shall not cause the Program or the Company to be considered an “investment company” within the meaning of the Investment Company Act of 1940, as amended.

(cc) “Performance Goal” means, with respect to each Award, that (i) the Market Value of a Phantom Unit subject to such Award exceeds the Base Value of such Phantom Unit as of the date as of which a Redemption Amount is determined with respect to such Award, and (ii) the value of the Investment to which such Award relates and the value of Investments in different equity holdings in the same entity, together with the value of all Follow-up Investments with respect to such Investments, exceeds the aggregate out-of pocket cost of such Investments and such Follow-up Investments to the Company and the Subsidiaries paid to the issuer or seller thereof (determined as of the date as of which a Redemption Amount is determined with respect to such Award). For purposes of clause (ii) of the preceding sentence, the Committee shall determine the value of the applicable Investments and Follow-up Investments by reference to (A) the value of each portion of such Investments with respect to which a Disposition has occurred as of the date of such Disposition, (B) the value of the portions of such Investments retained by the Company or a Subsidiary as of the date as of which the applicable Redemption Amount is determined, and (C) the value of the Distributions received by the Company or a Subsidiary with respect to such Investments prior to the date referred to in clause (B) (valued as of the date of receipt of each such Distribution). Further, the Committee shall determine the aggregate out-of pocket cost of the applicable Investments and Follow-up Investments without regard to any amount paid under the Program with respect thereto.

(dd) “Phantom Unit” means the Committee's determination of the unit by which to measure value, price, or amount with regard to any particular Investment. At the time that the first Award is made with respect to an Investment, the Committee shall determine in its sole discretion the number of Phantom Units into which such Investment shall be divided. If the Committee does not designate the number of Phantom Units into which a particular Investment is to be divided, then the Investment shall be divided into one million Phantom Units.

(ee) “Program” means this Continental Airlines, Inc. Officer Retention and Incentive Award Program, as amended from time to time.

(ff) “Publicly Traded” means, with respect to a particular Investment, that securities which are of the same class as the securities constituting all or substantially all of such Investment are either (i) registered under section 12 of the Securities Exchange Act of 1934, as amended, and listed on a U.S. national or regional stock exchange or reported by the NASDAQ National Market System or (ii) listed for trading on a national or regional stock exchange or market in a foreign country. An Investment shall also be considered to be Publicly Traded if the Committee determines that the Company or a Subsidiary could readily acquire by conversion, exchange, exercise or otherwise one or more securities described in the preceding sentence with respect to all or substantially all of such Investment, and, under such circumstances, the Committee shall make appropriate and equitable adjustments to affected PARs and Awards (including, without limitation, adjustments to the determinations of the Base Value and Market Value applicable to related Phantom Units) in connection with any redemption thereof under Article VI.

(gg) “Redeemable PARs” shall have the meaning assigned to such term in Section 6.2(a).

(hh) “Redemption Amount” means, with respect to a particular Vested PAR, the difference, if any (but not less than zero), as of a specified date between (i) the Market Value as of such date of the Phantom Unit relating to such PAR and (ii) the Base Value as of such date of such Phantom Unit.

(ii) “Redemption Election” shall have the meaning assigned to such term in Section 6.1.

(jj) “Redemption Notice” shall have the meaning assigned to such term in Section 6.1.

(kk) “Retirement” means, with respect to a Participant, the earlier of (i) the first date upon which such Participant has both attained 50 years of age and completed 20 or more years of service for vesting purposes under the Continental Retirement Plan, (ii) the first date upon which such Participant has both attained 55 years of age and completed 10 or more years of service for vesting purposes under the Continental Retirement Plan, or (iii) the date upon which such Participant has attained 65 years of age.

(ll) “Stockholder Disposition” means, with respect to each Investment, a distribution or other disposition of all or a portion of such Investment to the Company's stockholders on a pro-rata basis.

(mm) “Subsidiary” means any entity (other than the Company) with respect to which the Company, directly or indirectly through one or more other entities, owns equity interests possessing 50 percent or more of the total combined voting power of all equity interests of such entity (excluding voting power that arises only upon the occurrence of one or more specified events).

(nn) “Termination of Service” means the termination of a Participant's employment for any reason whatsoever so that such Participant is no longer an employee of the Company or any Subsidiary.

(oo) “Trading Day” means, with respect to any Investment that is Liquid, a day during which trading in securities generally occurs in the principal securities market in which such Investment is traded.

(pp) “Transferee” means any person, corporation, partnership, limited liability company or partnership, association, trust, or other entity or organization that is not the Company or a Subsidiary.

(qq) “Valuation Expert” means, with respect to each Investment, a nationally recognized investment banking firm experienced in the valuation of property similar to such Investment.

(rr) “Vested Interest” means the portion, if any, of an Award that is vested in accordance with Article V.

(ss) “Vested PARs” means the number of PARs subject to a Participant's Award in which such Participant has a Vested Interest, determined by multiplying (i) the total number of PARs subject to such Award at the Date of Grant by (ii) the Participant's Vested Interest as of the date the number of Vested PARs is being determined.

(tt) “Window Period” shall mean the 15-day period that begins on (and includes) the first business day of the month of each February, May, August, and November.

(uu) “Window Redemption Date” means, with respect to each Window Period and each Investment, the first Trading Day that occurs with respect to such Investment after the last day of such Window Period.

2.2 Number, Gender, Headings, and Periods of Time.

Wherever appropriate herein, words used in the singular shall be considered to include the plural, and words used in the plural shall be considered to include the singular. The masculine gender, where appearing in the Program, shall be deemed to include the feminine gender. The headings of Articles, Sections, and Paragraphs herein are included solely for convenience. If there is any conflict between such headings and the text of the Program, the text shall control. All references to Articles, Sections, and Paragraphs are to the Program unless otherwise indicated. Any reference in the Program to a period or number of days, weeks, months, or years shall mean, respectively, calendar days, calendar weeks, calendar months, or calendar years unless expressly provided otherwise.

### III. Administration

3.1 Administration by the Committee.

The Program shall be administered by the Committee. The action by a majority of the members of the Committee shall be the act of the Committee. The Committee may delegate such administrative matters hereunder as it deems appropriate to officers of the Company to the extent such delegation does not cause compensation hereunder which is intended to constitute “performance-based” compensation for purposes of section 162(m) of the Code not to be treated as such “performance-based” compensation.

3.2 Powers of the Committee.

The Committee shall supervise the administration and enforcement of the Program according to the terms and provisions hereof and shall have the sole discretionary authority and all of the powers necessary to accomplish these purposes. The Committee shall have all of the powers specified for it under the Program, including, without limitation, the power, right, or authority: (a) to select Eligible Employees to receive Awards under the Program; (b) to determine all provisions, conditions, and terms relating to any Award, including, without limitation, determinations as to the Date of Grant, the Base Value, the Market Value, the number of PARs subject to an Award, and any adjustments thereto; (c) from time to time to establish rules and procedures for the administration of the Program, which are not inconsistent with the provisions of the Program or the Incentive Plan 2000, and any such rules and procedures shall be effective as if included in the Program; (d) to construe in its discretion all terms, provisions, conditions, and limitations of the Program, any Award, and any Award Notice; (e) to correct any defect or to supply any omission or to reconcile any inconsistency that may appear in the Program or in any Award or Award Notice in such manner and to such extent as the Committee shall deem appropriate; (f) to make determinations as to whether a Disposition of an Investment has occurred; (g) to make determinations as to whether an Investment is Publicly Traded and/or Liquid; (h) to make determinations as to whether an equity holding constitutes a Follow-up Investment; (i) to make determinations as to whether the Performance Goal applicable to an Award has been satisfied; (j) to make determinations than an equity holding is not an Investment, pursuant to Section 2.1 (s) hereof; (k) to determine whether, with respect to an Award, a Participant will forfeit 10% of the Redemption Amount upon a redemption of the Award (or any portion thereof) relating to such Investment pursuant to Section 6.1 hereof; (l) to certify in writing, prior to the payment of any amount under the Program with respect to an Award, whether the Performance Goal relating to such Award has in fact been satisfied; and (m) to make all other determinations necessary or advisable for the administration of the Program. If the Committee determines that the cost of administration of the Program, or the cost to the Company or its Subsidiaries of administration or oversight of Investments, becomes material, the Committee may take such costs into account in determining Base Value relating to future Awards.

3.3 Committee Decisions Conclusive; Standard of Care.

The Committee shall, in its sole discretion exercised in good faith (which, for purposes of this Section 3.3, shall mean the application of reasonable business judgment), make all decisions and determinations and take all actions necessary in connection with the administration of the Program. All such decisions, determinations, and actions by the Committee shall be final, binding, and conclusive upon all persons. The Committee shall not be liable for any decision, determination, or action taken in good faith or upon reliance in good faith on the records of the Company or information presented to the Committee by the Company's officers, employees, or other persons (including the Valuation Experts and their employees and representatives) as to matters the Committee reasonably believes are within such other person's professional or expert competence. If a Participant disagrees with any decision, determination, or action made or taken by the Committee, then the dispute will be limited to whether the Committee has satisfied its duty to make such decision or determination or take such action in good faith. No liability whatsoever shall attach to or be incurred by any past, present or future stockholders, officers or directors, as such, of the Company or any of its Subsidiaries, under or by reason of the Program or the administration thereof, and each Participant, in consideration of receiving benefits and participating hereunder, expressly waives and releases any and all claims relating to any such liability.

### IV. Participation, Awards and Award Notices

4.1 Participation.

Each individual who is an Eligible Employee is eligible to be selected to be a Participant in the Program. Subject to the provisions of Sections 4.3, 4.4, and 4.5, (a) participation in the Program and the granting of Awards to Eligible Employees shall be determinations made by and in the discretion of the Committee and (b) Awards shall be granted by the Committee from time to time, and at such times, as the Committee in its sole discretion may determine. The Committee may grant any number of Awards to any one Eligible Employee without regard to the number of Awards granted to any other Eligible Employee.

4.2 Award Notices.

The Company shall provide an Award Notice to each individual who receives an Award relating to a particular Investment. Each Award Notice evidencing an Award shall specify (a) the Date of Grant of such Award, (b) the Investment to which such Award relates, (c) the number of PARs subject to such Award, (d) the Base Value of each Phantom Unit subject to a PAR granted under such Award, (e) the number of Phantom Units into which the related Investment has been divided (if other than one million Phantom Units), (f) the vesting schedule and/or other requirements pursuant to which the Participant who holds such Award shall obtain a Vested Interest (to the extent such schedule or requirements differ from the provisions contained in Article V), (g) whether the Participant will forfeit 10% of the Redemption Amount upon a redemption of the Award (or any portion thereof) relating to such Investment pursuant to Section 6.1 hereof, and (h) such other terms and conditions as the Committee may determine in its sole discretion.

4.3 Limitations on PARs.

The aggregate number of PARs that may be subject to Awards granted with respect to a particular Investment shall not exceed (a) with respect to any one Participant, 3.75% of the number of Phantom Units into which such Investment has been divided, and (b) with respect to all Participants, 25% of the number of Phantom Units into which such Investment has been divided.

4.4 Special Provisions Concerning Awards to Officers.

Unless an affected Officer is notified otherwise in writing by the Committee prior to the last day of the 90-day period referred to in clause (ii) of the fourth sentence of Section 2.1 (s) (or, if applicable, prior to the Date of Grant of an Award referred to in the fifth sentence of Section 2.1(s)) with respect to an Investment that becomes subject to the Program:

(a) each Officer who is employed by the Company or a Subsidiary on the date an Investment is acquired by the Company or a Subsidiary, as applicable (or, with respect to an Investment described in the fifth sentence of Section 2.1(s), the Date of Grant of an Award described in such sentence), shall receive an Award with respect to such Investment as of such date (provided, however, that Officers who are so employed on the Effective Date shall receive an Award on such date with respect to Investments acquired by the Company or a Subsidiary prior to such date which are made subject to the Program by the Committee as of such date); and

(b) the number of PARs that shall be subject to each Award to an Officer pursuant to Section 4.4(a) shall be no less than an amount equal to (i) the Officer Percentage that is applicable to such Officer as of the Date of Grant of such Award multiplied by (ii) the number of Phantom Units into which the Investment that is the subject of such Award has been divided (with the result rounded down to the nearest whole PAR).

Notwithstanding the foregoing, the provisions of this Section 4.4 shall not apply with respect to any Follow-up Investment.

4.5 Special Provisions Concerning Awards with respect to Follow-up Investments.

If (a) a Participant has received an Award with respect to an Existing Investment prior to the date a Follow-up Investment with respect to such Existing Investment is acquired by the Company or a Subsidiary, (b) such Participant is either an Eligible Employee or has a Vested Interest in such Award as of the date of such acquisition, and (c) such Award has not been canceled pursuant to Section 5.3, then such Participant shall receive an Award with respect to such Follow-up Investment as of the date the Follow-up Investment is acquired by the Company or a Subsidiary. In the case of a Participant who is an Eligible Employee at the time such Award is made, (i) such Participant's Vested Interest in such Award shall at all times be equal to his or her Vested Interest in his or her Award relating to the Existing Investment and (ii) the number of PARs subject to such Award shall be no less than an amount that bears the same ratio to the number of Phantom Units into which such Follow-up Investment has been divided as the number of PARs subject to such Participant's Award relating to the Existing Investment bears to the number of Phantom Units into which the Existing Investment was divided. In the case of a Participant who is not an Eligible Employee at the time such Award is made, (A) such Participant's Vested Interest in such Award shall at all times be equal to 100% and (B) the number of PARs subject to such Award shall equal (1) such Participant's Vested Interest in his or her Award relating to the Existing Investment multiplied by (2) an amount that bears the same ratio to the number of Phantom Units into which such Follow-up Investment has been divided as the number of PARs subject to such Participant's Award relating to the Existing Investment bears to the number of Phantom Units into which the Existing Investment was divided. The provisions of this Section 4.5 shall apply separately to each Award held by a Participant with respect to such Existing Investment.

4.6 Adjustments to Outstanding Awards.

In the event of (a) any recapitalization, reorganization, merger, consolidation, combination, split-up, split-off, spin-off, exchange, or other relevant change in capitalization of any company or other entity issuing securities constituting an Investment occurring after the date of the grant of any Award relating to such Investment, (b) a capital contribution by the Company or a Subsidiary to any company or entity issuing securities constituting an Investment occurring after the date of the grant of any Award relating to such Investment, (c) the exercise by the Company or a Subsidiary of an option, warrant, or other purchase right constituting an Investment after the date of the grant of any Award relating to such Investment, or (d) the occurrence of any other event which, in the judgment and sole discretion of the Committee, should cause a change in the rights of the Participants with respect to their Awards under the Program, then the Committee shall make such adjustments under the Program and to any outstanding Awards with respect to the number of PARs subject to such Awards, the Base Value of the Phantom Units subject to such PARs, the number of Phantom Units relating to such Investment or any other term or condition applicable to such PARs or Awards (including, without limitation, dividing an Award into two or more Awards) as, in the sole discretion of the Committee, shall (i) be equitable and appropriate under the circumstances, (ii) be consistent with the intent of the Program, and (iii) preclude an increase in the compensation payable to a Participant with respect to an Award beyond that which was intended under the Program. Subject to the principles set forth in clauses (i), (ii), and (iii) of the preceding sentence, Awards may also be adjusted by the Committee as provided in other provisions of the Program. Any adjustments made by the Committee pursuant to this Section shall be final, binding, and conclusive on all parties.

### V. Vesting of Awards

5.1 Determination of Vested Interest.

Subject to the provisions of Section 4.5, a Participant shall obtain a Vested Interest in an Award at the rate of 6.25% for each full three-month period (commencing on the Date of Grant of such Award) that the Participant remains continuously employed by the Company or a Subsidiary. Further, if a Participant incurs a Termination of Service by reason of death, Disability or Retirement, then such Participant shall obtain on the date of such termination a 100% Vested Interest in all then outstanding Awards held by such Participant; provided, however, that if such Retirement occurs prior to the second anniversary of the Effective Date, (a) such Participant's Vested Interest in all Awards shall be frozen, (b) the Vested Interest of such Participant in his or her Awards shall not increase after such date, and (c) the Nonvested PARs (determined as of such date) subject to such Awards shall be surrendered to the Company and canceled. Notwithstanding the preceding provisions of this Section, the Committee may, in its sole discretion, provide in an Award Notice or in an employment agreement a different vesting schedule or vesting provisions pursuant to which a Participant shall acquire a Vested Interest in his or her Award(s).

5.2 Termination of Service Other Than for Cause and not by Reason of Death, Disability or Retirement.

Except as provided in Section 5.4 and unless otherwise provided in an Award Notice or a Participant's employment agreement, as of the date a Participant incurs a Termination of Service other than for Cause (and not by reason of death, Disability or Retirement), (a) such Participant's Vested Interest in all Awards shall be frozen, (b) the Vested Interest of such Participant in his or her Awards shall not increase after such date, and (c) the Nonvested PARs (determined as of such date) subject to such Awards shall be surrendered to the Company and canceled; provided, however, that if, upon such Participant's Termination of Service other than for Cause (and not by reason of death, Disability or Retirement) any of such Participant's stock options granted under the Incentive Plan 2000 or any other stock option plan or program of the Company vest in their entirety (except as a result of the expiration of an employment agreement occurring prior to the second anniversary of the Effective Date), then such Participant's Awards shall vest in their entirety (so that such Participant has a 100% Vested Interest in such Awards).

5.3 Termination of Service for Cause.

Upon a determination by the Committee that a Participant has incurred a Termination of Service for Cause, (a) all outstanding Awards (including the Vested PARs and Nonvested PARs subject thereto) shall be canceled, effective as of the date of such Termination of Service, (b) no outstanding PARs under Awards held by such Participant shall be redeemable, and (c) no amount, including, without limitation, any amount payable under Article VI, shall be paid under the Program to such Participant from and after the date of such Termination of Service. Such Participant shall surrender all outstanding Awards to the Company, and all Awards of such Participant shall be canceled.

5.4 Special Change in Control Vesting Provisions.

A Participant who is employed by the Company or a Subsidiary on the date a Change in Control occurs shall obtain on such date a 100% Vested Interest in all then outstanding Awards held by such Participant; provided, that if the Change in Control is the result of a business combination with Northwest or any Person (as defined in the Incentive Plan 2000) controlling, controlled by or under common control with Northwest, then the Committee shall determine whether, in connection with such business combination, a change in the composition of the persons with authority to exercise policy-making functions with respect to the business of the Company has or is reasonably expected to occur, such that the expectations of employees of the Company concerning the direction and management of the Company would be reasonably expected to be materially affected, and a Change in Control shall be deemed to occur as a result of such business combination only if the Committee determines that such a change has or is reasonably expected to occur. Notwithstanding any determination by the Committee that such a change has not or is not reasonably expected to occur, if a Participant who is employed by the Company or a Subsidiary on the date of the closing of a business combination with Northwest or any Person controlling, controlled by or under common control with Northwest which, but for the determination by the Committee, would constitute a Change in Control, incurs a Termination of Service at any time during the two-year period following the date of such closing, and such Termination of Service is for any reason other than Cause or the voluntary resignation of such Participant, then such Participant shall obtain on the date of such Termination of Service a 100% Vested Interest in all then outstanding Awards held by such Participant.

5.5 Accelerated Vesting.

At any time, and from time to time, the Committee may in its sole discretion accelerate the vesting of an Award such that the Participant who holds such Award will have a greater Vested Interest than such Participant would have otherwise had pursuant to the preceding provisions of this Article V or the vesting schedule set forth in the Award Notice evidencing such Award or such Participant's employment agreement. Actions by the Committee pursuant to this Section may vary among Participants and may vary among the Awards held by an individual Participant.

### VI. Award Redemptions

6.1 Redemptions Elected by a Participant.

On or before the first day of each Window Period, the Committee shall (a) identify each Investment that the Committee anticipates will be Liquid as of the Window Redemption Date immediately following the last day of such Window Period and (b) provide notice of the same (the “Redemption Notice”) to each Participant who is expected to be holding Vested PARs (determined as of such Window Redemption Date) under an Award relating to such Investment as of such Window Redemption Date. During each Window Period, a Participant who has received a Redemption Notice (or, should the Committee fail to deliver such notice, who should have received a Redemption Notice hereunder) may elect by irrevocable written notice to the Committee to redeem as of the next following Window Redemption Date all or any portion of such Participant's unredeemed Vested PARs that relate to an Investment that is both (1) specified in the Committee's Redemption Notice for such Window Period (or, but for the failure to deliver such notice, would have been so specified) and (2) Liquid as of such Window Redemption Date. Any such election (a “Redemption Election”) must specify the Award to which such election relates and the number of such Participant's unredeemed Vested PARs under such Award to which such election shall apply. If a Participant makes a Redemption Election with respect to an Award, then the Company shall pay to the Participant the Redemption Amount applicable to the Vested PARs that are the subject of such Redemption Election; provided, however, that if the Committee has made a determination described in the Award Notice that the Participant will forfeit 10% of the Redemption Amount upon a redemption of the Award (or any portion thereof) pursuant to this Section 6.1, then such Participant shall receive a payment of only 90% of such Redemption Amount, and the remaining 10% of such Redemption Amount shall be forfeited to the Company. The amount described in the preceding sentence shall be determined as of the applicable Window Redemption Date (and the Market Value of the Phantom Unit subject to each such PAR shall be determined under (A) Section 2.1(v)(i) if the Company or a Subsidiary, as applicable, makes a Disposition corresponding to a Participant's Redemption Election or (B) Section 2.1 (v)(ii) if no such Disposition is made), and shall be paid to the Participant in a single lump sum cash payment as soon as administratively practicable, but not later than 30 days, after the applicable Window Redemption Date. Upon such redemption, the PARs so redeemed shall be surrendered to the Company, and all such redeemed PARs shall be canceled. If a Participant makes a Redemption Election with respect to an Award and the Investment relating to such Award is not Liquid as of the applicable Window Redemption Date, then such Redemption Election shall be void and of no effect. Notwithstanding the preceding provisions of this Section, prior to any payment pursuant to this Section with respect to an Award, the Committee must certify in writing that the Performance Goal was satisfied with respect to such Award as of the applicable Window Redemption Date. Such certification shall be made as soon as administratively feasible, but no later than 30 days, after the end of the applicable Window Period and shall be delivered to the Secretary of the Company. For purposes of this Section, approved minutes of the Committee in which the certification is made shall be treated as a written certification.

6.2 Redemption Upon Disposition of All or a Portion of an Investment.

(a) For purposes of this Section 6.2, each Investment shall be deemed to be subdivided into a number of sub-investments equal to the number of Phantom Units into which such Investment was divided. A number of such sub-investments equal to the number of PARs that have been awarded to a Participant under an Award relating to such Investment shall be associated with such Participant's Award. Upon any Disposition of all or a portion of an Investment, the Company or a Subsidiary, as applicable, shall be deemed to have first disposed of the sub-investments corresponding to PARs that have been redeemed pursuant to Section 6.1 contemporaneously with or prior to such Disposition, and no payments under this Section 6.2 shall be made with respect to the disposition of any such sub-investments. The remaining provisions of this Section 6.2 shall apply only when (and to the extent that) the Company and the Subsidiaries have disposed of a number of sub-investments that exceed the corresponding number of PARs that have been redeemed pursuant to Section 6.1 and this Section 6.2 prior to such disposition (an “Excess Disposition”). As soon as administratively feasible after the Disposition of all or a portion of an Investment that results in an Excess Disposition, the Committee shall determine, with respect to each outstanding Award relating to such Investment, the number of PARs, if any, that shall be subject to redemption or cancellation pursuant to this Section 6.2 in connection with such Disposition. Such number of PARs with respect to an outstanding Award (the “Redeemable PARs”) shall equal A multiplied by B, where A equals (i) the number of sub-investments that constitute such Excess Disposition divided by (ii) the number of sub-investments into which such Investment was deemed divided pursuant to this Section 6.2(a), and B equals the number of unredeemed PARs subject to such outstanding Award at the time of such Disposition. The Committee shall also determine and certify in writing whether the Performance Goal was satisfied (determined as of the date of such Excess Disposition) with respect to each then outstanding Award relating to such Investment. If the Performance Goal was not so satisfied with respect to such an Award, then the Redeemable PARs shall be surrendered to the Company and canceled. If the Performance Goal was so satisfied with respect to such Award, then the Redeemable PARs shall be redeemed as provided in this Section. The Committee certifications required pursuant to this Section shall be delivered to the Secretary of the Company. For purposes of this Section, approved minutes of the Committee in which the certifications are made shall be treated as a written certification.

(b) Upon the occurrence of an Excess Disposition, the outstanding Redeemable PARs related thereto with respect to which the Performance Goal was satisfied as provided above shall remain outstanding, and each Participant who holds such Redeemable PARs shall continue to obtain a Vested Interest therein in accordance with the provisions of Article V until such Participant's Vested Interest becomes frozen in accordance with Article V or the Award under which such Redeemable PARs were granted is forfeited in accordance with Article V. Subject to the provisions of Section 5.3, as soon as administratively feasible, but not more than 10 days, after the later of the date of the Excess Disposition or the certification required by the Committee pursuant to Section 6.2(a), the Company shall make a redemption payment to each Participant who is entitled to a redemption pursuant to this Section in an amount equal to the Redemption Amount (determined as of the date of the Excess Disposition) applicable to the Redeemable PARs that are Vested PARs (determined as of the date of the Excess Disposition). In addition, within 10 days after each date upon which such Participant's remaining Redeemable PARs become Vested PARs, the Company shall make an additional redemption payment to such Participant in an amount equal to the Redemption Amount (determined as of the date of the Excess Disposition) applicable to such Redeemable PARs that become Vested PARs, together with 7% interest (compounded annually) on such additional redemption payment for the period beginning on the date of the payment to such Participant pursuant to the preceding sentence and ending on the date of payment of such additional redemption payment. Upon payment by the Company with respect to a Redeemable PAR as provide above, the PAR so redeemed shall be surrendered to the Company and canceled. All payments under this Section shall be made in cash.

6.3 Redemption Upon Expiration of Investment Period.

As soon as administratively feasible after the last day of the Investment Period relating to an Investment, the Committee shall certify in writing whether the Performance Goal was satisfied (determined as of the last day of such Investment Period (or as of the first business day following such date if such date is not a business day) (the “Measurement Date”)) with respect to each then outstanding Award relating to such Investment. If the Performance Goal was not so satisfied with respect to such an Award, then such Award shall be surrendered to the Company and canceled. If the Performance Goal was so satisfied with respect to such an Award, then the Company shall redeem the Vested PARs under such Award (determined as of the Measurement Date), and such Award (including the Vested PARs and Nonvested PARs subject thereto) shall be surrendered to the Company and canceled. The amount paid by the Company to a Participant who is entitled to a redemption payment pursuant to this Section with respect to such Participant's Vested PARs shall be the Redemption Amount applicable to such Vested PARs (determined as of the Measurement Date). A redemption payment provided for in this Section shall be paid to the Participant in a single lump sum cash payment as soon as administratively practicable, but not later than 60 days, after the last day of the applicable Investment Period. The Committee certifications required pursuant to this Section shall be delivered to the Secretary of the Company. For purposes of this Section, approved minutes of the Committee in which the certifications are made shall be treated as a written certification.

6.4 Limitations with respect to Redemption Payments.

Notwithstanding any provision herein to the contrary, (a) except as expressly provided in this Article VI, a Participant shall not have any right to any payment under the Program, (b) in no event shall a payment be made with respect to the portion of an Award in which a Participant does not have a Vested Interest, and (c) in no event shall a payment be made with respect to an Award in excess of the limitations on the maximum amount that may be paid with respect to Awards contained in the Incentive Plan 2000.

### VII. Stockholder Approval, Termination, and Amendment of Program

7.1 Stockholder Approval.

The Program shall be effective as of the Effective Date; provided that the Incentive Plan 2000 is approved by the Company's stockholders in the manner required under section 162(m) of the Code at the Company's 2000 annual meeting of stockholders. Notwithstanding any provision herein to the contrary, no payment under the Program shall be made to or on behalf of any Participant unless the Incentive Plan 2000 is so approved by the Company's stockholders. If the Company's stockholders do not so approve the Incentive Plan 2000, then (a) all Awards under the Program shall be void ab initio and of no further effect and (b) the Program shall terminate.

7.2 Termination and Amendment.

The Committee may amend the Program at any time and from time to time, and the Committee may at any time terminate the Program; provided, however, that the Program may not be amended or terminated in a manner that would impair (a) the rights of a Participant with respect to an outstanding Award or (b) the right of a Participant with respect to an Existing Investment as of the date of such amendment or termination to receive (or the Base Value of) an Award with respect to a related Follow-up Investment pursuant to Section 4.5, without, in each such case, the consent of such Participant. The Committee shall remain in existence after the termination of the Program for the period determined necessary by the Committee to facilitate the termination of the Program, and all provisions of the Program that are necessary, in the opinion of the Committee, for equitable operation of the Program during such period shall remain in force.

### VIII. Miscellaneous Provisions

8.1 No Effect on Employment Relationship or SERP.

For all purposes of the Program, a Participant shall be considered to be in the employment of the Company as long as he or she remains employed on a full-time basis by the Company or any Subsidiary. Nothing in the adoption of the Program, the grant of Awards, or the payment of amounts under the Program shall confer on any person the right to continued employment by the Company or any Subsidiary or affect in any way the right of the Company (or a Subsidiary, if applicable) to terminate such employment at any time. Unless otherwise provided in a written employment agreement, the employment of each Participant shall be on an at-will basis, and the employment relationship may be terminated at any time by either the Participant or the Participant's employer for any reason whatsoever, with or without cause. Any question as to whether and when there has been a termination of a Participant's employment for purposes of the Program, and the reason for such termination, shall be determined solely by and in the discretion of the Committee, and its determination shall be final, binding, and conclusive on all parties. Any Participant who has a supplemental executive retirement plan (SERP) with the Company or any Subsidiary understands and agrees, by accepting any Award under the Program, that any Redemption Amount paid with respect to any Award constitutes a cash bonus paid under a long term incentive plan or program adopted by Company and thus shall be excluded from such Participant's cash compensation for purposes of calculating benefits payable under such SERP.

8.2 Prohibition Against Assignment or Encumbrance.

No Award, PAR, or other right, title, interest, or benefit hereunder shall ever be assignable or transferable, or liable for, or charged with any of the torts or obligations of a Participant or any person claiming under a Participant, or be subject to seizure by any creditor of a Participant or any person claiming under a Participant. No Participant or any person claiming under a Participant shall have the power to anticipate or dispose of any Award, PAR, or other right, title, interest, or benefit hereunder in any manner until the same shall have actually been distributed free and clear of the terms of the Program. Payments with respect to an Award shall be payable only to the Participant (or (a) in the event of a Disability that renders such Participant incapable of conducting his or her own affairs, any payment due under the Program to such Participant shall be made to his or her duly appointed legal representative and (b) in the event of the death of a Participant, any payment due under the Program to such Participant shall be made to his or her estate). The provisions of the Program shall be binding on all successors and assigns of a Participant, including without limitation the estate of such Participant and the executor, administrator or trustee of such estate, or any receiver or trustee in bankruptcy or representative of the Participant's creditors.

8.3 Unfunded, Unsecured Program.

The Program shall constitute an unfunded, unsecured obligation of the Company to make payments of incentive compensation to certain individuals from its general assets in accordance with the Program. Each Award and PAR granted under the Program merely constitutes a mechanism for measuring such incentive compensation and does not constitute a property right or interest in the Company, any Subsidiary, or any of their assets (including, without limitation, any Investment or any Distribution with respect to any Investment). Neither the establishment of the Program, the granting of Awards, nor any other action taken in connection with the Program shall be deemed to (a) create any interest in an Investment (nor to constitute the direct or indirect sale, transfer, assignment, pledge or other disposition thereof (or of any part thereof) or of any interest therein), (b) create an escrow or trust fund of any kind, (c) create any fiduciary relationship of the Company or any Subsidiary, or of any officer, director, employee or agent thereof, with respect to any Investment or any Participant, or (d) restrict or affect in any way the acquisition, holding, voting, disposition or the taking of any action with respect to any Investment by the Company or any Subsidiary.

8.4 No Rights of Participant.

No Participant shall have any security or other interest in any assets of the Company or any Subsidiary (including, without limitation, any Investment or any Distribution with respect to any Investment) as a result of participation in the Program. Participants and all persons claiming under Participants shall rely solely on the unsecured promise of the Company set forth herein, and nothing in the Program, an Award or an Award Notice shall be construed to give a Participant or anyone claiming under a Participant any right, title, interest, or claim in or to any specific asset, fund, entity, reserve, account, or property of any kind whatsoever owned by the Company or any Subsidiary or in which the Company or any Subsidiary may have an interest now or in the future; but each Participant shall have the right to enforce any claim hereunder in the same manner as a general creditor. Neither the establishment of the Program nor participation hereunder shall create any right in any Participant to make any decision, or provide input with respect to any decision, relating to any Investment or the business of the Company or any Subsidiary.

8.5 Tax Withholding.

The Company and the Subsidiaries are hereby directed to deduct and withhold, or cause to be withheld, from a Participant's payment under the Program, or from any other payment to such Participant, an amount necessary to satisfy any and all tax withholding obligations arising under applicable local, state, federal, or foreign laws associated with such payment. The Company and the Subsidiaries may take any other action as may in its opinion be necessary to satisfy all obligations for the payment and withholding of such taxes.

8.6 No Effect on Other Compensation Arrangements.

Nothing contained in the Program or any Participant's Award or Award Notice shall prevent the Company or any Subsidiary from adopting or continuing in effect other or additional compensation arrangements affecting any Participant. Nothing in the Program shall be construed to affect the provisions of any other plan or program maintained by the Company or any Subsidiary.

8.7 Subsidiaries.

The Company may require any Subsidiary employing a Participant to assume and guarantee the Company's obligations hereunder to such Participant, either at all times or solely in the event that such Subsidiary ceases to be a Subsidiary.

8.8 Governing Law.

Except to the extent federal law applies and preempts state law, the Program shall be construed, enforced, and administered according to the laws of the State of Texas, excluding any conflict-of-law rule or principle that might refer construction of the Program to the laws of another State or country.

I claim:

1. A method of retaining employees as described above.

2. A method of compensating employees as described above.

3. Apparatus for determining the amount of a benefit to be paid to an employee as described above.
